(19) United States
(12) Patent Application Publication
(10) Pub. No.: US 2015/0375308 A1
(43) Pub. Date: Dec. 31, 2015

(54) Process for Machining Back Counterbores

(71) Applicant: Caterpillar Inc., Peoria, IL (US)

(72) Inventors: Rohit Arun Bhapkar, Peoria, IL (US); George Norbits, Mount Zion, IL (US)

(21) Appl. No.: 14/314,859

(22) Filed: Jun. 25, 2014

(51) Int. Cl. B23B 51/10; B23B 39/08; B23B 39/02; B23B 29/03; B23B 29/02

(52) U.S. Cl. CPC B23B 51/102; B23B 29/03; B23B 29/02; B23B 39/02; B23B 39/08

(57) ABSTRACT

A method for machining a counterbore in a machining component is provided. The method includes positioning a machining component with respect to a machining tool, the positioning of the machining component based on geometric specifications of the counterbore. The machining tool includes a boring bar, the boring bar angled based on the geometric specifications of the counterbore. The method further includes, with the head traversed through the bore, repositioning one of the machining component or the tool such that the cutting element comes in contact with the second side of the machining component and, with the cutting element in contact with the second side of the machining component, rotating at least one of the tool and the machining component.

### TECHNICAL FIELD OF THE DISCLOSURE

The present disclosure generally relates to machining counterbores and, more particularly, relates to apparatus, systems, and methods for machining back counterbores into components of machines.

### BACKGROUND OF THE DISCLOSURE

Processes involving cutting tools are often used to create counterbores on material surfaces. A counterbore is a bore which is concentric with a previously cut bore on a material surface. Counterbores may be flat-bottomed holes that enlarge a portion of an associated coaxial bore. Such counterbores are often used in designs wherein the head of a fastener, such as a hex head or socket head screw, is required to be flush with or below the level plane of a surface of a machine component. Counterbores may also be used to create a perpendicular surface for a fastener head on a non-perpendicular surface, where only enough material is removed so as to make the surface flat once the fastener is installed. Generally, counterbores are machined, with respect to an associated pilot bore, using cutting tools designed to the specification of the desired counterbore. Often, tools for cutting counterbores in a surface are made with standard dimensions for a certain size of insert.

During machining processes, counterbores can be produced using methods wherein the bore is on the opposing side of the surface from which the tool enters the pilot bore. In such processes, the counterbore may be machined using processes for creating back counterbores. A back counterbore is a counterbore created when a tool enters through a pilot bore and the tool machines the counterbore on the side of the machining surface opposite to the side from which the tool entered. Creating back counterbores requires different tools than the tools used for creating standard counterbores because the cutting element of the tool must completely fit within the pilot bore.

Various tools exist for creating back counterbores, said tools entering the pilot bore from the opposing side of the machining surface on which the counterbore is machined. One such modern tool for creating back counterbores includes a straight-line base body designed to fit a specific dimension of pilot bore and a cutting element which protrudes from base body once the tool has passed through the pilot bore. The cutting element of such a tool lays flush with the surface of the base body of the tool upon entering the pilot bore. When the back counterbore is to be cut by the tool, the cutting element protrudes from the base body. Such tools may require spring loaded or pneumatic means for ejecting the cutting element from its flush position with respect to the base body. Once the head of the tool, containing the cutting element, is through the pilot bore and the cutting element protrudes out from the base body, the base body is rotated while the cutting element is in contact with the machining surface. After rotation, the back counterbore is machined. The cutting element may then recess back in to the base body and the tool may be removed from the pilot bore. Such cutting tools are detailed further in U.S. Patent Application No. 2013/0330141 (“Deburring Tools for Deburring Bore Margins”)

While these tools and methods for using said tools are useful for machining back counterbores, the tools have complicated designs including many moving parts internal to the tool. Such parts may deteriorate over time, potentially causing part failure which may lead to a defective tool. Further, these tools having a pop-out cutting element are very expensive due to the complicated design and use of spring-loaded or pneumatic elements. Therefore, a need exists for more cost effective and robust methods and tools for machining back counterbores.

### SUMMARY OF THE DISCLOSURE

In accordance with one aspect of the present disclosure, a method is provided for machining a counterbore in a machining component, the machining component defining a bore. The method may include positioning the machining component with respect to a machining tool, the positioning of the machining component based on geometric specifications of the counterbore. The machining tool includes a boring bar, the boring bar, the boring bar angled based on the geometric specifications of the counterbore, a head attached to the boring bar, and a cutting element attached to the head. The method may further include traversing the boring bar of the machining tool through the bore on a first side of the machining component until the head of the machining tool emerges from a second side of the machining component. The method may further include repositioning one of the machining component or the tool, once the head has traversed through the bore, such that the cutting element comes in contact with the second side of the machining component. The method may further include rotating at least one of the tool and the machining component with the cutting element in contact with the second side of the machining component.

In accordance with another aspect of the present disclosure, a machining tool is provided for machining a counterbore in a machining component, the machining component defining a bore. The machining tool includes a boring bar, the boring bar contoured based on geometric specifications of the counterbore. The machining tool further includes a tool head attached to the boring bar, the tool head traversing through the bore on a first side of the machining component until it emerges from a second side of the machining component during the machining of the counterbore, the machining component being angled based on the geometric specifications of the counterbore. The machining tool further includes a cutting element, the cutting element making contact with the second side of the machining component when at least one of the tool or the machining component is repositioned after the tool traverses the bore and cutting the counterbore into the second side of the machining component when at least one of the tool and the machining component is rotated.

In accordance with yet another aspect of the present disclosure, a system is provided for machining a counterbore in a machining component, the machining component defining a bore. The system includes a machining tool, the machining tool including a boring bar, the boring bar angled based on geometric specifications of the counterbore, a head attached to the boring bar, and a cutting element attached to the head. The system may further include a controller in operative control of the machining table and the machining tool. The controller may provide instructions for positioning the machining component with respect to a machining tool, the positioning of the machining component based on geometric specifications of the counterbore, and traversing the boring bar of the machining tool through the bore on a first side of the machining component until the head of the machining tool emerges from a second side of the machining component. The controller may further provide instructions for repositioning one of the machining surface or the tool, once the boring bar has traversed through the bore, such that the cutting element comes in contact with the second side of the machining component, and rotating at least one of the tool and the machining component with the cutting element in contact with the second side of the machining component.

Other features and advantages of the disclosed systems and principles will become apparent from reading the following detailed disclosure in conjunction with the included drawing figures.

### BRIEF DESCRIPTION OF THE DRAWINGS

FIG. 1 is a side view of a tool for machining back counterbores in accordance with the present disclosure.

FIG. 2 is a side view of a machined component in accordance with the present disclosure, the machined component defining a bore and a counterbore bored by the tool of FIG. 1.

FIG. 3 is a flowchart for an exemplary method for machining back counterbores, using the tool of FIG. 1, in accordance with the present disclosure.

FIG. 4 is a schematic diagram showing an example embodiment of a step of the block diagram of FIG. 3, the step including positioning the machining component with respect to the tool, in accordance with the present disclosure.

FIG. 5 is a schematic diagram showing an example embodiment of a step of the block diagram of FIG. 3, the step including traversing the tool through the bore of the machining component, in accordance with the present disclosure.

FIG. 6 is a schematic diagram showing an example embodiment of a step of the block diagram of FIG. 3, the step including repositioning the machining component for cutting a counterbore, in accordance with the present disclosure.

FIG. 7 is a schematic diagram showing an example embodiment of a step of the block diagram of FIG. 3, the step including repositioning the tool for cutting a counterbore, in accordance with the present disclosure.

FIG. 8 is a schematic diagram showing an example embodiment of a step of the block diagram of FIG. 3, the step including rotating the tool to cut a counterbore, in accordance with the present disclosure.

FIG. 9 is a schematic diagram showing an example embodiment of a step of the block diagram of FIG. 3, the step including rotating the machining component to cut a counterbore, in accordance with the present disclosure.

FIG. 10 is a schematic diagram showing an example system for machining back counterbores in accordance with the present disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION OF THE DISCLOSURE

The present disclosure provides methods, apparatus, and systems for machining back counterbores. The proceeding embodiments of the disclosure may be used for machining bores in machinery components. The machinery components may be formed of heavy metallic materials which require bores and associated counterbores for fasteners. However, such systems, methods, and tools are not limited to such applications.

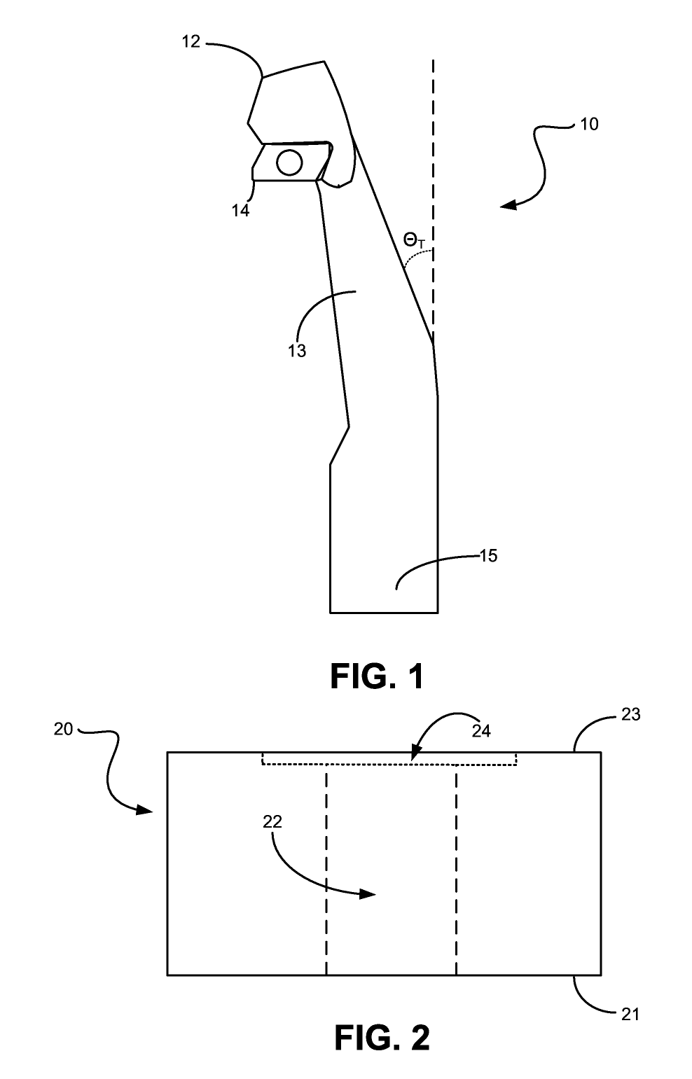

An example tool 10 for machining back counterbores is illustrated in FIG. 1. The tool 10 includes a base body 15, a contoured boring bar 13, and a tool head 12 having an associated cutting element 14. The contoured boring bar 13 of the cool 10 is contoured based on the geometry of a desired counterbore to be bored into a machining component. For example, the geometry of the desired counterbore (e.g., the depth, width, and height of the counterbore with respect to a pilot bore) can be used to determine an angle Θ_{T}, which is then used to angle the contoured boring bar 13 with respect to the base body 15.

Turning now to FIG. 2, with continued reference to FIG. 1, an example machining component 20, on which the tool 10 may bore a counterbore 24 (denoted by dotted lines), is shown in FIG. 2. The machining component 20 defines a pilot bore 22, (denoted by dashed lines) which has been previously bored into the machining component 20. During a back counterboring operation, the tool head 12 will traverse the bore 22 from the first side 21 of the machining component 21 until it emerges from the second side 23 of the machining component 20, the second side 23 being opposite from the first side 21. Synchronously, the machining component 20 may be indexed to a proper angle for the traversing of the tool 10 through the pilot bore 22. When at least one of the tool 10 or the machining component 20 is repositioned for boring, the cutting element 14 of the head will make contact with the machining component 20 for a cutting operation. The cutting element 14 attached to the tool head 12 may be any cutting insert suitable for boring into the machining component 20. Once the cutting element 14 is in contact with the machining component 20, at least one of the tool 10 and the machining component 20 may be rotated to remove materials, thusly creating the counterbore 24.

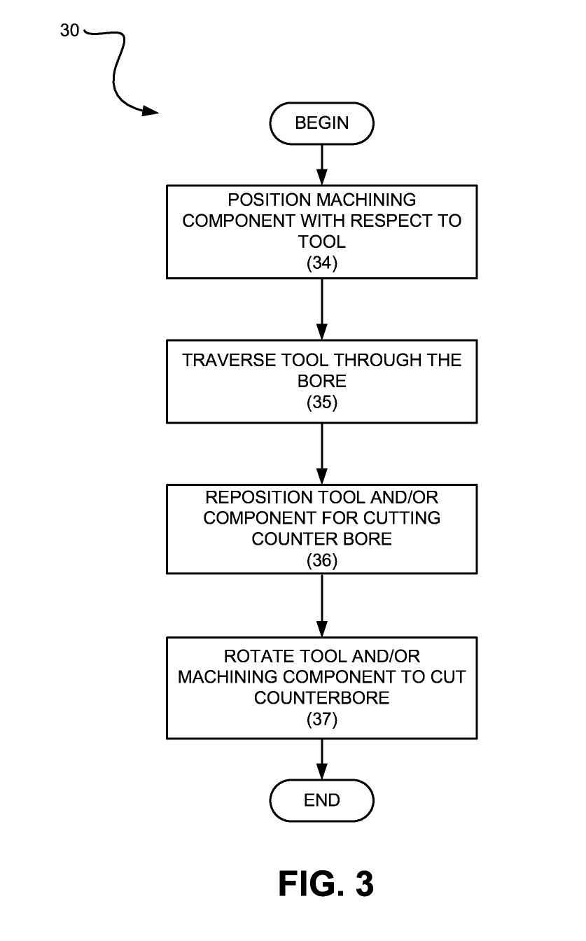

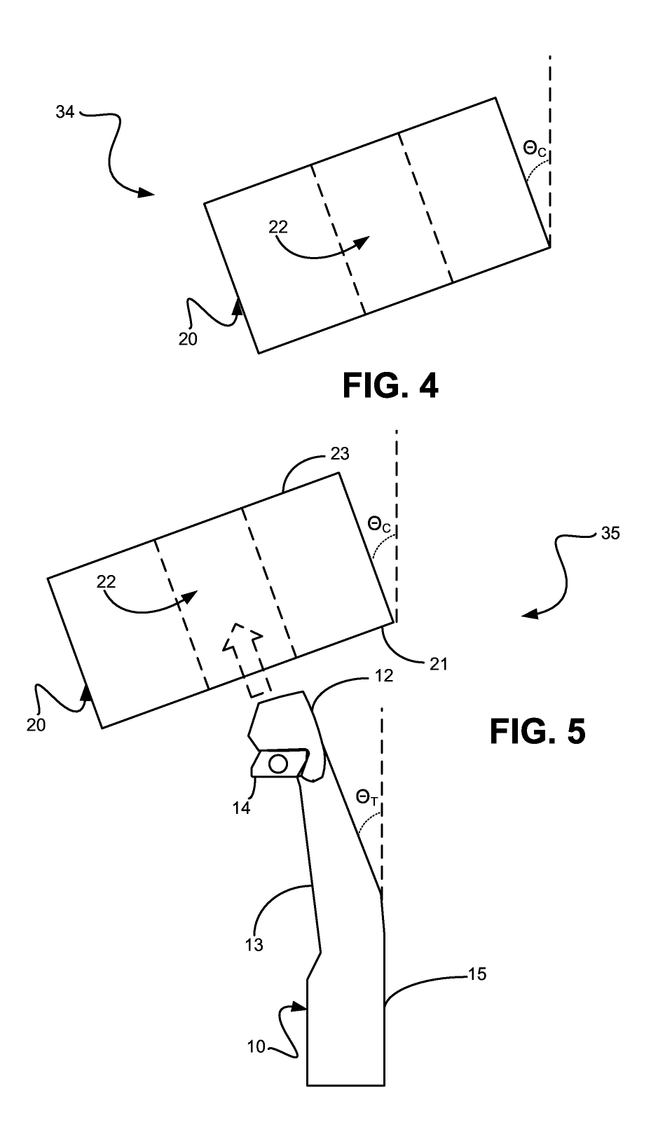

Referring now to FIG. 3, an example block diagram for a machining method 30 is shown for machining the back counterbore 24 into the machining component 20 of FIG. 2, using the tool 10 of FIG. 1. The example steps 34-37 are further detailed diagrammatically in FIGS. 4-7, respectively. Like reference numbers referring to elements of the tool 10 and the machining component 20 are used throughout FIGS. 1-9.

At step 34, as further detailed in FIG. 4, the machining component 20 is positioned for the counterboring process. Positioning of the machining component 20 may be based on the geometry of the desired counterbore (e.g., the counterbore 24). Using geometric calculations, the positioning may be configured to position the machining component 20 such that the tool 10 may easily traverse the pilot bore 22. The positioning of the machining component 20 may be based on an angle Θ_{T}, which is based on the geometric specifications of the counterbore. The angle Θ_{T} may be configured so that the contoured boring bar 13 and head 12 of the tool 10 may easily traverse the pilot bore 22. In some examples, positioning of the machining component 20 may be performed using a machining table configured for executing the machining method 30.

After the machining component 20 has been positioned, the tool 10 is traversed through the pilot bore 22 (step 35). As shown in the detailed embodiment of step 35 in FIG. 5, the positioned machining component 20 is aligned with the tool 10 such that the tool head 12 and contoured boring bar 13 will traverse the pilot bore 22 (see: the dashed arrow of FIG. 5 denoting traversing direction), entering from the first side 21 of the machining component. The traversing motion will end once the tool head 12, including the cutting element 14, emerges from the second side 23 of the machining component 20. Traversing may be accomplished by positioning the machining component 20, positioning the tool 10, and/or synchronously positioning both the machining component 20 and the tool 10. In an example embodiment, positioning of the tool 10 during traversing may be performed by a machine spindle. In another example embodiment, positioning of the machining component 20 during traversing may be performed using a machining table.

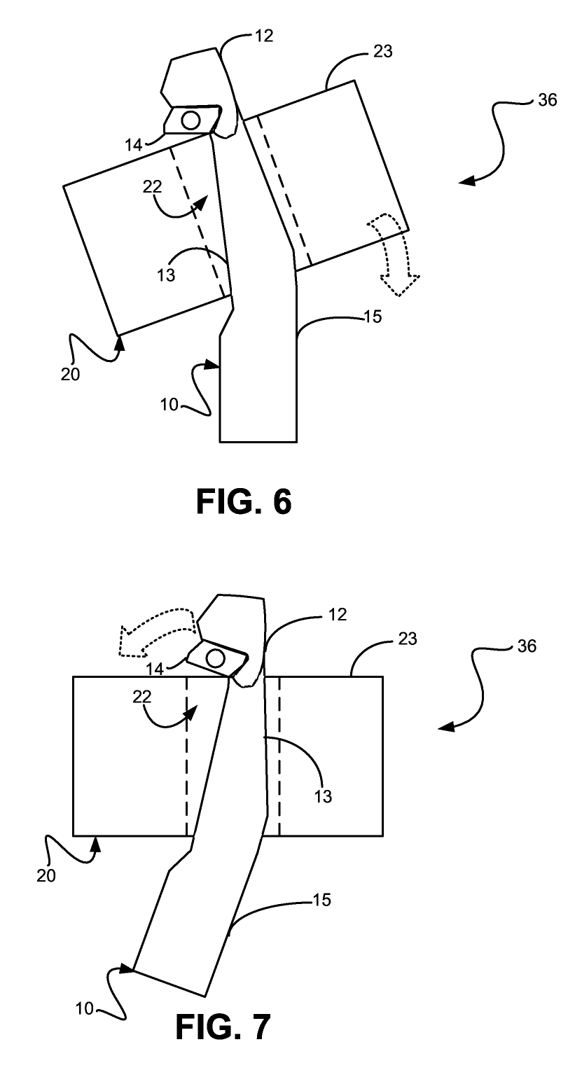

After the tool head 12 and contoured boring bar 13 have traversed the pilot bore 22, at least one of the tool 10 and the machining component 20 are repositioned such that the cutting element 14 will come in contact with the second side 23 of the machining component 20 for the counterboring process (step 36). In the example embodiment of step 36 in FIG. 6, the machining component 20 is shown to be repositioned by the dotted arrow; once repositioned in said motion, the cutting element 14 will make contact with the second side 23 of the machining component. In an example embodiment, repositioning of the machining component 20 during repositioning may be performed using a machining table. Additionally or alternatively, the repositioning may be performed as shown in the example step 36 of FIG. 7, wherein the tool 10 is repositioned such that the cutting element 14 comes in contact with the second side 23 of the machining component 20. In an example embodiment, repositioning of the tool 10 during may be performed by a machine spindle. Further, the above mentioned repositioning processes may be performed by moving the machining component 20 (FIG. 6) and moving the tool 10 (FIG. 7) synchronously.

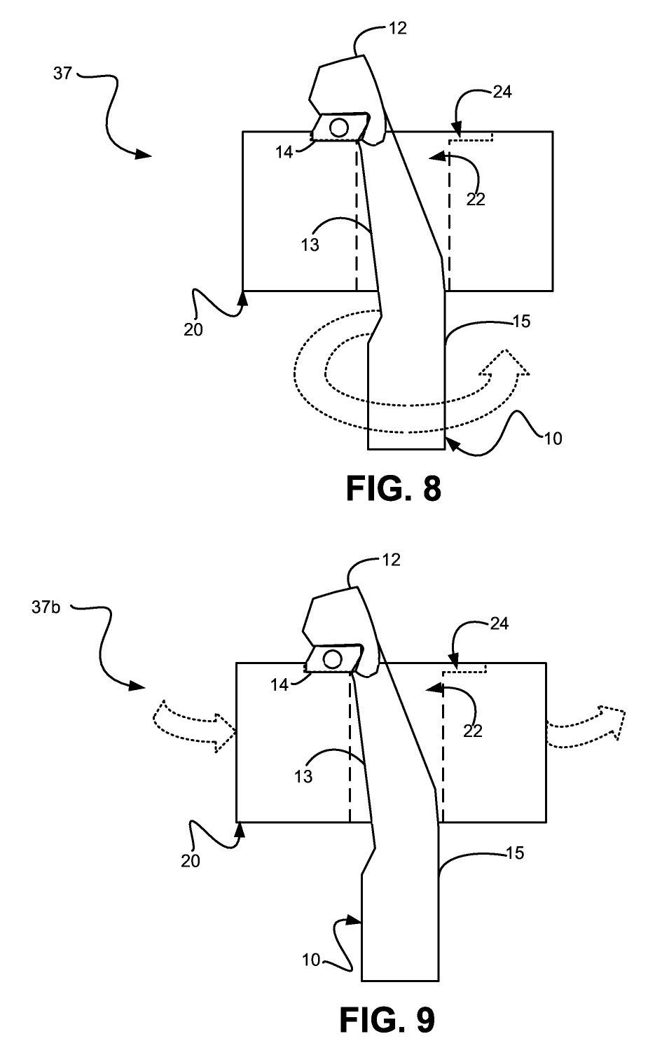

Once the tool 10 is in position with the cutting element 14 being in contact with the second side 23 of the machining component 20, at least one of the tool 10 and the machining component 20 is rotated to bore the counterbore 24 in the machining component 20 (step 37). Rotation of the tool 10 and/or machining component 20 may be clockwise or counterclockwise. In the example embodiment of step 37 in FIG. 8, the tool 10 is shown to be rotated by the dotted arrow. During rotation, the cutting element 14 will cut the counterbore 24 into the second side 23 of the machining component 20. In such an example embodiment, rotation of the tool 10 may be performed by a machine spindle. Additionally or alternatively, the rotation may be performed as shown in the example step 37 of FIG. 9 (rotation shown by dotted arrows), wherein the machining component 20 is rotated such that the cutting element 14 will cut the counterbore 24 into the second side 23 of the machining component 20. In an example embodiment, rotation of the machining component 20 may be performed using a machining table. In an example embodiment, cutting the counter bore 24 in the second side 23 may be performed by synchronously rotating the tool 10 (FIG. 8) and rotating the machining component 20 (FIG. 9).

After the counterbore 24 has been cut, the machining component 20 may return to the positioning shown in FIG. 4, based on the geometric specifications of the counter bore, and the tool 10 may be traversed back out of the pilot bore 22 through the first side 21 of the machining component 20. Returning the machining component 20 to the positioning based on the geometric specifications of the counter bore may be performed using a machining table.

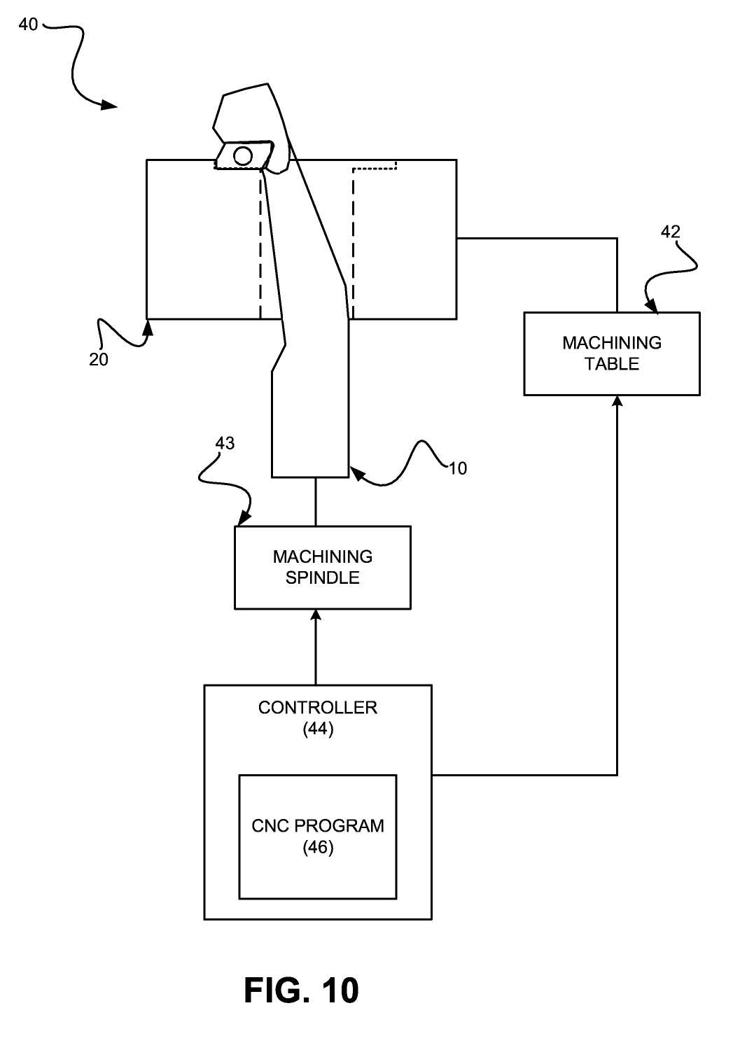

In an example embodiment, the method 30 shown in FIGS. 3-9 may be performed using a system 40, as illustrated in FIG. 10. The system 40 includes a controller 44 for controlling positioning, rotation, and any other motions of the tool 10 and the machining component 20. The controller 44, generally, is configured via a control algorithm to use predetermined parameters (e.g., angular velocities of rotation, speed of traverse, geometric specifications of counterbores, etc.) to provide instructions to various downstream components of the system 40. The controller 44 may include various components for executing software instructions designed to control machining hardware. For example, the controller 44 may include a central processing unit (CPU), a random access memory (RAM), a read-only memory (ROM), input/output elements, etc. The controller 44 may execute machine readable instructions stored in the controller 44 on a mass storage device, RAM, ROM, local memory, and/or on a removable storage medium such as a CD, DVD, and/or flash memory device.

Algorithms and instructions executed by the controller 44 may be part of a computer numerical control (CNC) program 46 associated with the controller 44. The CNC program 46 provides automation of machine tools by operating with precisely programmed commands encoded on a storage medium. In some examples, the CNC program 46 may execute the methods of FIGS. 3-9 by controlling the machining component 20 and the tool 10 using a machining table 42 and a machining spindle 43, respectively.

In another embodiment, the controller 44 may provide instructions for positioning the machining component 20 with respect to the tool 10 by the positioning of the machining component 20 based on geometric specifications of the counterbore 24. The controller 44 may also provide the machining table 42 with instructions for traversing the contoured boring bar 13 through the pilot bore 22 on the first side 21 until the head of the tool 10 emerges from the second side 23 of the machining component 20. With the contoured boring bar 13 traversed through the pilot bore 22, the controller 44 may provide instructions for the machining table 42 to reposition the machining surface 20 such that the cutting element 14 comes in contact with the second side 13 of the machining component 20. Additionally or alternatively, the controller 44 may provide instructions to reposition the tool 10, either via the machine spindle 43 or any other means for positioning the tool 10, such that the cutting element 14 comes in contact with the second side 13 of the machining component 20. Further, with the cutting element 14 in contact with the second side 13 of the machining component 20, the controller 44 may provide instructions for rotating at least one of the tool 10 and the machining component 20. Rotating the tool 10 and the machining component 20 may be performed by the machine spindle 43 and the machining table 42, respectively. Lastly, after the counterbore 24 has been cut, the controller 44 may provide the machining table 44 instructions to return the machining component 20 to the positioning based on the geometric specifications of the counter bore, and provide instructions to traverse the tool 10 back out of the pilot bore 22 through the first side 21 of the machining component 20.

### INDUSTRIAL APPLICABILITY

The present disclosure relates generally to improved systems, methods, and tools for machining back counterbores. In particular, the tool 10 and associated method 30 may be used to provide an inexpensive means for machining back counterbores because the tool 10 has a design absent expensive parts, such as the protruding cutting elements of the prior art. In general, the disclosed systems provide for a robust and cost effective means for machining back counterbores. Additionally, the provided contoured design of the tool 10 and method 30 using angled motion of the components may provide the ability to create wider counterbores than prior tools and methods for producing counterbores.

It will be appreciated that the present disclosure provides an apparatus, system, and method for machining back counterbores with improved cost efficiency and part durability. While only certain embodiments have been set forth, alternatives and modifications will be apparent from the above description to those skilled in the art. These and other alternatives are considered equivalents and within the spirit and scope of this disclosure and the appended claims.

What is claimed is:

1. A method for machining a counterbore in a machining component, the machining component defining a bore, the method comprising:
positioning the machining component with respect to a machining tool, the positioning of the machining component based on geometric specifications of the counterbore, the machining tool comprising:
a boring bar, the boring bar angled based on the geometric specifications of the counterbore;
a head attached to the boring bar; and
a cutting element attached to the head;
traversing the boring bar of the machining tool through the bore on a first side of the machining component until the head of the machining tool emerges from a second side of the machining component;
repositioning one of the machining component or the tool, once the head has traversed through the bore, such that the cutting element comes in contact with the second side of the machining component; and
rotating at least one of the tool and the machining component with the cutting element in contact with the second side of the machining component.

2. The method of claim 1, wherein positioning the machining component with respect to the machining tool is performed using a machining table associated with the machining component.

3. The method of claim 2, wherein the machining table receives instructions from a computer numerical control (CNC) program for indexing the machining table to position the machining component with respect to the machining tool.

4. The method of claim 1, wherein rotating the machining component is performed using a machining table associated with the machining component.

5. The method of claim 4, wherein the machining table receives instructions from a CNC program to rotate the machining table.

6. The method of claim 1, wherein rotating the tool is performed using a machining spindle associated with the tool.

7. The method of claim 6, wherein the machining spindle receives instructions from a CNC program to rotate the tool.

8. The method of claim 1, further comprising:
returning the machining component to the positioning based on geometric specifications of the counterbore; and
traversing the tool out of the bore through the first side of the machining component.

9. The method of claim 8, wherein the machining table receives instructions from a CNC program for indexing the machining table to return the machining component to the positioning based on geometric specifications of the counterbore.

10. The method of claim 1, wherein positioning the machining component with respect to the machining tool is based on an angle associated with the geometry of the counterbore.

11. A machining tool for machining a counterbore in a machining component, the machining component defining a bore, the machining tool comprising:
a boring bar, the contoured boring bar contoured based on geometric specifications of the counterbore;
a tool head attached to the boring bar, the tool head traversing through the bore on a first side of the machining component until it emerges from a second side of the machining component during the machining of the counterbore, the machining surface being angled based on the geometric specifications of the counterbore; and
a cutting element, the cutting element making contact with the second side of the machining surface when at least one of the tool or the machining surface is repositioned after the tool traverses the bore and cutting the counterbore into the second side of the machining surface when at least one of the tool and the machining surface is rotated.

12. The machining tool of claim 11, further comprising a tool base attached to the boring bar.

13. The machining tool of claim 12, wherein the tool base is configured to be used in association with a machine spindle.

14. The machining tool of claim 11, wherein the contoured boring bar is contoured based on an angle associated with the geometry of the counterbore.

15. A system for machining a counterbore in a machining surface, the machining component defining a bore, the system comprising:
a machining table operatively associated with the machining component;
a machining tool, the machining tool comprising:
a boring bar, the boring bar angled based on geometric specifications of the counterbore;
a head attached to the boring bar; and
a cutting element attached to the head; and
a controller in operative control of the machining table and the machining tool, the controller providing instructions for:
positioning the machining component with respect to a machining tool, the positioning of the machining component based on geometric specifications of the counterbore;
traversing the boring bar of the machining tool through the bore on a first side of the machining component until the head of the machining tool emerges from a second side of the machining component;
repositioning one of the machining component or the tool, once the boring bar has traversed through the bore, such that the cutting element comes in contact with the second side of the machining component; and
rotating at least one of the tool and the machining component with the cutting element in contact with the second side of the machining component,.

16. The system of claim 15, wherein the instructions provided by the controller are a CNC program.

17. The system of claim 15, wherein positioning the machining component with respect to the machining tool is performed by the machining table.

18. The system of claim 15, wherein rotating the machining component is performed by the machining table.

19. The system of claim 15, further comprising a machine spindle operatively associated with the machining tool and controlled by the controller.

20. The system of claim 19, wherein rotating the tool is performed by the machine spindle.
